(19) United States
(12) Patent Application Publication
(10) Pub. No.: US 2018/0213553 A1
(43) Pub. Date: Jul. 26, 2018

(54) DEVICE AND METHOD FOR SELECTIVELY TRANSMITTING OR RECEIVING NETWORK COORDINATION INFORMATION OF MESH NETWORK

(71) Applicant: MediaTek Singapore Pte. Ltd., Solaris (SG)

(72) Inventors: Francesc Boixadera Espax, Cambridge (GB); David Metcalf, Cambridge (GB); Miquel Eduard Oliver Cardona, Swavesey (GB); Mark Murphy, Cambridge (GB)

(73) Assignee: MediaTek Singapore Pte. Ltd., Solaris (SG)

(21) Appl. No.: 15/411,296

(22) Filed: Jan. 20, 2017

(51) Int. Cl. H04W 72/12; H04W 28/04

(52) U.S. Cl. CPC H04W 72/1278; H04W 28/044; H04W 72/121

(57) ABSTRACT

Aspects of the disclosure include a wireless device in a mesh network. The wireless device includes a processing circuit and a transceiver. The processing circuit is configured to update a first selection model based on first operation history information of operating the wireless device in the mesh network, and determine whether the wireless device is to transmit or receive subsequent mesh control information (MCI) of the mesh network during a subsequent MCI transmitting/receiving (Tx/Rx) window based on the first selection model. The transceiver is configured to transmit or receive the subsequent MCI during the subsequent MCI Tx/Rx window as determined based on the first selection model.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In some applications, a mesh network may include plural wireless devices that function as communication nodes of the mesh network. Each one of the communication nodes of the mesh network is communicatively connected with at least another one of the communication nodes of the mesh network, and a data packet may be forwarded from one node to another node within the mesh network. At least two types of information may be transmitted among various communication nodes of the mesh network, including network coordination information and user data. The network coordination information allows the communication nodes to work with one another in order to form traffic paths within the mesh network, on which the user data may be transmitted from a source node to a destination node of the mesh network. In some applications, the network coordination information may include mesh network identification information, synchronization information, routing information, radio resource information, and/or the like.

### SUMMARY

Aspects of the disclosure provide a wireless device in a mesh network. The wireless device includes a processing circuit and a transceiver. The processing circuit is configured to update a first selection model based on first operation history information of operating the wireless device in the mesh network, and determine whether the wireless device is to transmit or receive subsequent mesh control information (MCI) of the mesh network during a subsequent MCI transmitting/receiving (Tx/Rx) window based on the first selection model. The transceiver is configured to transmit or receive the subsequent MCI during the subsequent MCI Tx/Rx window as determined based on the first selection model.

In an embodiment, the first operation history information includes at least local network information, previously received MCI from another wireless device, reception signal quality of the previously received MCI, whether the wireless device transmitted or received MCI during a previous MCI Tx/Rx window, or a value of a random variable that corresponds to a probability function of likelihood of transmitting MCI among a predetermined number of MCI windows. The processing circuit may determine based on the first selection model that the wireless device is to transmit the subsequent MCI during the subsequent MCI Tx/Rx window when the local network information is inconsistent with the previously received MCI, the reception signal quality of the previously received MCI is less than a first predetermined threshold, or the value of the random variable is less than a second predetermined threshold.

In addition, the processing circuit may further update a second selection model based on second operation history information of operating the wireless device in the mesh network, and determine whether the wireless device is to transmit or receive subsequent mesh synchronization information (MSYNC) of the mesh network during a subsequent MSYNC Tx/Rx window based on the second selection model. Also, the transceiver may further transmit or receive the subsequent MSYNC during the subsequent MSYNC Tx/Rx window as determined based on the second selection model. The second operation history information may include at least previously received MSYNC, reception signal quality of the previously received MSYNC, whether the wireless device transmitted or received MSYNC during a previous MSYNC Tx/Rx window, or a value of a random variable that corresponds to a probability function of likelihood of transmitting MSYNC among a predetermined number of MSYNC windows.

The processing circuit may identify a control channel of the mesh network based on received MSYNC, and the transceiver can transmit or receive the subsequent MCI through the identified control channel. Also, the processing circuit may identify a data traffic channel of the mesh network based on information embedded in received MCI, and the transceiver can transmit or receive user data through the identified data traffic channel. An effective communication range reachable by the wireless device using the data traffic channel may be less than an effective communication range reachable by the wireless device using the control channel.

In an embodiment, when the wireless device is determined to receive the subsequent MCI during the subsequent MCI Tx/Rx window, the transceiver can receive plural versions of the subsequent MCI from other wireless devices in the mesh network during the subsequent MCI Tx/Rx window. The processing circuit can generate a consolidated version of the subsequent MCI based on the plural versions of the subsequent MCI.

Aspects of the disclosure further provide a method for a wireless device in a mesh network. The method includes updating a first selection model based on first operation history information of operating the wireless device in the mesh network, determining, by a processing circuit of the wireless device based on the first selection model, whether the wireless device is to transmit or receive a subsequent mesh control information (MCI) of the mesh network during a subsequent MCI transmitting/receiving (Tx/Rx) window, and transmitting or receiving, by a transceiver of the wireless device, the subsequent MCI during the subsequent MCI Tx/Rx window as determined based on the first selection model.

The method may further include updating a second selection model based on second operation history information of operating the wireless device in the mesh network, determining, by the processing circuit of the wireless device based on the second selection model, whether the wireless device is to transmit or receive subsequent mesh synchronization information (MSYNC) of the mesh network during a subsequent MSYNC Tx/Rx window, and transmitting or receiving the subsequent MSYNC during the subsequent MSYNC Tx/Rx window as determined based on the second selection model.

Aspects of the disclosure further provide non-transitory computer readable medium storing program instructions for causing a processing circuit of a wireless device to perform the steps including updating a first selection model based on first operation history information of operating the wireless device in the mesh network, determining, by the processing circuit of the wireless device based on the first selection model, whether the wireless device is to transmit or receive a subsequent mesh control information (MCI) of the mesh network during a subsequent MCI transmitting/receiving (Tx/Rx) window, and transmitting or receiving, by a transceiver of the wireless device, the subsequent MCI during the subsequent MCI Tx/Rx window as determined based on the first selection model.

In one embodiment, the program instructions can further cause the processing circuit of the wireless device to perform the steps including updating a second selection model based on second operation history information of operating the wireless device in the mesh network, determining, by the processing circuit of the wireless device based on the second selection model, whether the wireless device is to transmit or receive subsequent mesh synchronization information (MSYNC) of the mesh network during a subsequent MSYNC Tx/Rx window, and transmitting or receiving the subsequent MSYNC during the subsequent MSYNC Tx/Rx window as determined based on the second selection model.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary functional block diagram of a mesh network that includes a plurality of wireless devices according to an embodiment of the disclosure;

FIG. 2 shows an exemplary functional block diagram of a wireless device in the mesh network in FIG. 1 according to an embodiment of the disclosure;

FIG. 3A shows an exemplary timing diagram of a control channel of the mesh network in FIG. 1 according to an embodiment of the disclosure;

FIG. 3B shows an exemplary timing diagram for illustrating allocation of mesh control information (MCI) transmitting/receiving (Tx/Rx) windows according to an embodiment of the disclosure;

FIG. 4 shows an exemplary diagram of a mesh network for illustrating various effective communication ranges of a wireless device according to an embodiment of the disclosure;

FIG. 5A shows an exemplary diagram of a wireless device that receives MCI from other wireless devices during a given MCI Tx/Rx window according to an embodiment of the disclosure;

FIG. 5B shows an exemplary timing diagram of receiving MCI from plural wireless devices during a given MCI Tx/Rx window according to an embodiment of the disclosure;

FIGS. 6A-6C shows exemplary diagrams of a mesh network at different stages for illustrating propagating MCI across the mesh network according to an embodiment of the disclosure;

FIG. 7 shows an exemplary flow chart outlining a process for determining whether to transmit or receive subsequent MCI of a mesh network during a subsequent MCI Tx/Rx window according to an embodiment of the disclosure; and

FIG. 8 shows an exemplary flow chart outlining a process for determining whether to transmit or receive subsequent mesh synchronization information (MSYNC) of a mesh network during a subsequent MSYNC Tx/Rx window according to an embodiment of the disclosure.

### DETAILED DESCRIPTION OF EMBODIMENTS

In accordance with some embodiments of the present disclosure, network coordination information, such as mesh synchronization information (MSYNC) and/or mesh control information (MCI), may be broadcasted by only a few communication nodes in a mesh network in order to more efficiently propagate any updates to the network coordination information. Whether a wireless device in the mesh network is to transmit or receive the MSYNC and/or MCI can be determined by the wireless device itself based on corresponding selection models, as opposed to being determined by a centralized controller of the mesh network, if any. The selection models, such as a MSYNC selection model and a MCI selection model, may be constantly updated based on operation history information collected by the corresponding wireless device. In some embodiments, even without a centralized controller, the chance of collisions of the broadcasted MSYNC and/or MCI may be reduced or avoided by aligning the operation of the communication nodes using properly configured selection models.

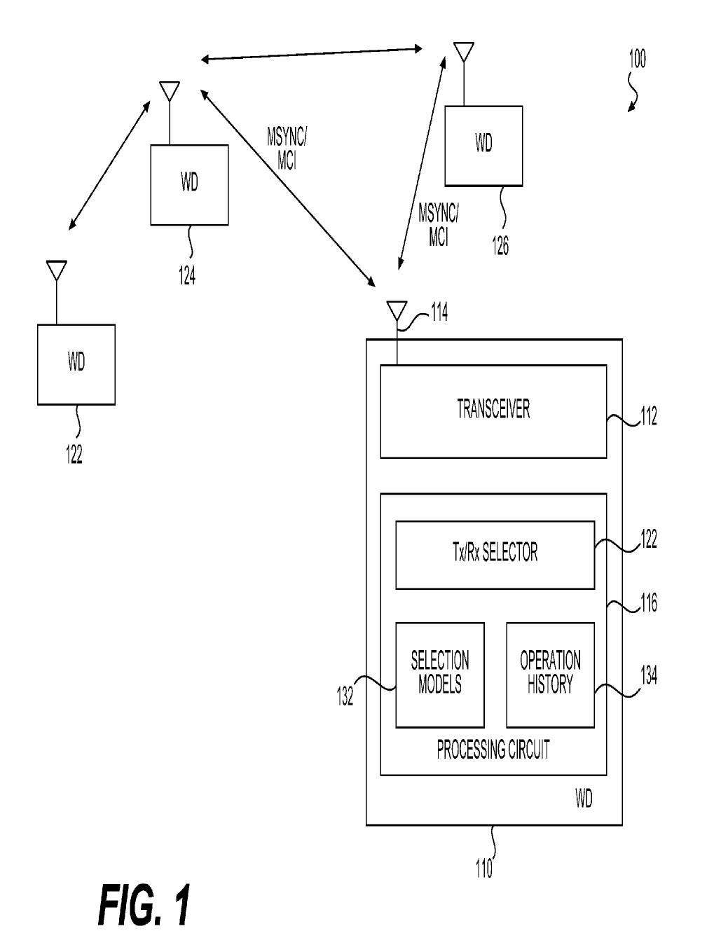

FIG. 1 shows an exemplary functional block diagram of a mesh network 100 that includes a plurality of wireless devices (WD) 110, 122, 124, and 126 according to an embodiment of the disclosure. Each one of the wireless devices 110, 122, 124, and 126 functions as a communication node of the mesh network 100 and may be a fixed wireless device (e.g., a wireless router, a wireless bridge, or an access point) or a portable wireless device (e.g., a laptop, a tablet, or a mobile phone). The wireless devices 110, 122, 124, and 126 are capable of wirelessly communicating with at least one other wireless device that participates in the mesh network 100. In some examples, the wireless devices 110, 122, 124, and 126 may wirelessly communicate with one another according to various communication protocols, such as an Institute of Electrical and Electronics Engineers (IEEE) 802.11 based protocol (e.g., WiFi network), an IEEE 802.15 based protocol (e.g., Bluetooth network), or the like. A mesh network protocol may define how to form a mesh network based on the various communication protocols, such as based on a WiFi network and/or a Bluetooth network. In at least one example, the mesh network protocol may define a mesh network based on WiFi ad hoc technology.

A wireless device in the mesh network 100 may be communicatively connected with only one wireless device, such as the wireless device 122 is only communicatively connected with the wireless device 124. Also, a wireless device in the mesh network 100 may be communicatively connected with two or more wireless devices, such as the wireless device 110 is communicatively connected with the wireless devices 124 and 116, the wireless device 126 is communicatively connected with the wireless devices 124 and 110, and the wireless device 124 is communicatively connected with wireless devices 122, 126, and 110.

Of course, the mesh network 100 in FIG. 1 is only a non-limiting example. In some examples, a mesh network may include a different number of communication nodes and may have a network topology different from that of the mesh network 100.

The wireless device 110 includes a transceiver 112, an antenna 114, and a processing circuit 116. The processing circuit 116 may further include a transmitting/receiving (Tx/Rx) selector 122, one or more selection models 132, and operation history information 134 of operating the wireless device 110 in the mesh network 100. The transceiver 112 can transmit or receive information to or from the wireless devices 124 and 126 via the antenna 114 using radio frequency signals. Such information may include network coordination information of the mesh network 100, for example, mesh synchronization information (MSYNC) and the mesh control information (MCI) of the mesh network 100. In some examples, the MSYNC may include mesh network identification information, time stamps, and/or synchronization information. The MSYNC allows a wireless device to discover the mesh network 100, adjust a local timer, and/or identify a MCI Tx/Rx window that MCI may be broadcasted. Moreover, the MCI may include mesh network identification information, routing information, and/or radio resource information. The MCI allows a wireless device to identify a data traffic channel for transmitting user data and/or to which communication node a data packet should be forwarded in order to form a traffic path from a source node to a destination node of the mesh network 100.

In some examples, the transceiver 112 is capable of transmitting and/or receiving information via a single channel at a time, and the corresponding wireless device 110 is sometimes referred to as a single-radio wireless device. When the transceiver 112 can only transmitting and/or receiving information via a single channel at a time, the transceiver 112 may need to stop transmitting and/or receiving user data during the MCI Tx/Rx window and/or the MSYNC Tx/Rx window. In some examples, the transceiver 112 is capable of transmitting and/or receiving information via multiple channels at a time, and the corresponding wireless device 110 is sometimes referred to as a multi-radio wireless device. When the transceiver 112 can transmitting and/or receiving information via multiple channels at a time, the transceiver 112 may continue transmitting and/or receiving user data during the MCI Tx/Rx window and/or the MSYNC Tx/Rx window.

In operation, the processing circuit 116 can identify the mesh network 100 by detecting broadcasted signatures as defined according to a predetermined mesh network protocol, such as a preamble indicating a starting point of a MSYNC Tx/Rx window or other types of signatures that may indicate a predetermined position of a transmission frame. Once a signature is detected, the processing circuit 116 may recognize a corresponding MSYNC Tx/Rx window based on the detected signature and receive the broadcasted MSYNC accordingly. Based on the received MSYNC, the wireless device 110 can determine other MSYNC Tx/Rx windows and MCI Tx/Rx windows based on the predetermined mesh network protocol and the information embedded in the received MSYNC and/or other received MSYNC and/or MCI. After the wireless device 110 discovers and joins the mesh network, the processing circuit 116 can determine a subsequent MSYNC Tx/Rx window and/or a subsequent MCI Tx/Rx window based on the received MSYNC and/or MCI and the predetermined mesh network protocol.

The processing circuit 116 can update the operation history information 134 based on the interaction between the wireless device 110 and the mesh network 100. The processing circuit 116 can further update the selection models 132, such as updating various parameters, enabling or disabling decision paths of a decision-tree algorithm, or the like, based on the operation history information 134. The Tx/Rx selector 122 of the processing circuit 116 may determine, using one of the selection models 132 that is applicable to MCI Tx/Rx selection and updated based on the operation history information, whether the wireless device 110 is to transmit or receive subsequent MCI of the mesh network 100 during the subsequent MCI Tx/Rx window. Moreover, the Tx/Rx selector 122 of the processing circuit 116 may determine, using another one of the selection models 132 that is applicable to MSYNC Tx/Rx selection and updated based on the operation history information, whether the wireless device 110 is to transmit or receive subsequent MSYNC of the mesh network 100 during the subsequent MSYNC Tx/Rx window.

In some examples, when determining whether to transmit or receive subsequent MCI of the mesh network 100 during the subsequent MCI Tx/Rx window, the Tx/Rx selector 112 may relied upon an MCI selection model that is updated based on operation history information, which includes one or more of local network information, previously received MCI from other wireless device(s), reception signal quality of the previously received MCI, whether the wireless device transmitted or received MCI during a previous MCI Tx/Rx window, and a value of a random variable that corresponds to a probability function of likelihood of transmitting MCI among a predetermined number of MCI windows, and the like.

The determination of whether to transmit or receive MSYNC at any given MSYNC Tx/RX window may be implemented in a manner similar to that for the MCI Tx/Rx windows. In some examples, when determining whether to transmit or receive subsequent MSYNC of the mesh network 100 during the subsequent MSYNC Tx/Rx window, the Tx/Rx selector 112 may relied upon an MSYNC selection model that is updated based on the operation history information, which may include one or more of previously received MSYNC from other wireless device(s), reception signal quality of the previously received MSYNC, whether the wireless device 110 transmitted or received MSYNC during a previous MSYNC Tx/Rx window, and a value of a random variable that corresponds to a probability function of likelihood of transmitting MSYNC among a predetermined number of MSYNC windows, and the like. In some examples, previously received MCI may also be analyzed and used to determine whether to transmit or receive MSYNC during the subsequent MSYNC Tx/Rx window.

The processing circuit 116 of the wireless device 110 can determine the timing of the subsequent MSYNC Tx/Rx window based on listening to a signature signal at candidate control channels, which are defined according to the predetermined mesh network protocol recognizable by the wireless devices 110, 122, 124, and 126. The processing circuit 116 of the wireless device 110 can determine the timing of the subsequent MCI Tx/Rx window based on at least the timing of a corresponding MSYNC Tx/Rx window, the predetermined mesh network protocol, and/or information embedded in the received MSYNC. For example, the processing circuit 116 may determine a starting time of the subsequent MCI Tx/Rx window based on a starting time of the subsequent MSYNC Tx/Rx window and a relation therebetween, where the relationship may be determined based on the predetermined mesh network protocol and/or the information embedded in the received MSYNC.

Also, the processing circuit 116 can identify a control channel of the mesh network based on received MSYNC, and the transceiver 112 can transmit or receive the subsequent MCI through the identified control channel. The processing circuit 116 can also identify a data traffic channel of the mesh network 100 based on information embedded in received MCI. The transceiver 112 can transmit or receive user data through the identified data traffic channel.

In some examples, an effective communication range reachable by the wireless device 110 when using the data traffic channel is less than an effective communication range reachable by the wireless device 110 when using the control channel. Such difference in the corresponding effective communication ranges may be implemented by one or a combination of setting a carrier frequency of the control channel to be lower than a carrier frequency of the data traffic channel (e.g., at a band below 2 GHz versus a band above 2 GHz), adopting a coding scheme for the control channel that is more redundant and robust than a coding scheme for the data traffic channel, allowing at any given time a less number of communication nodes that are transmitting using the control channel than the communication nodes that are transmitting using the data traffic channel to reduce interference, and/or the like.

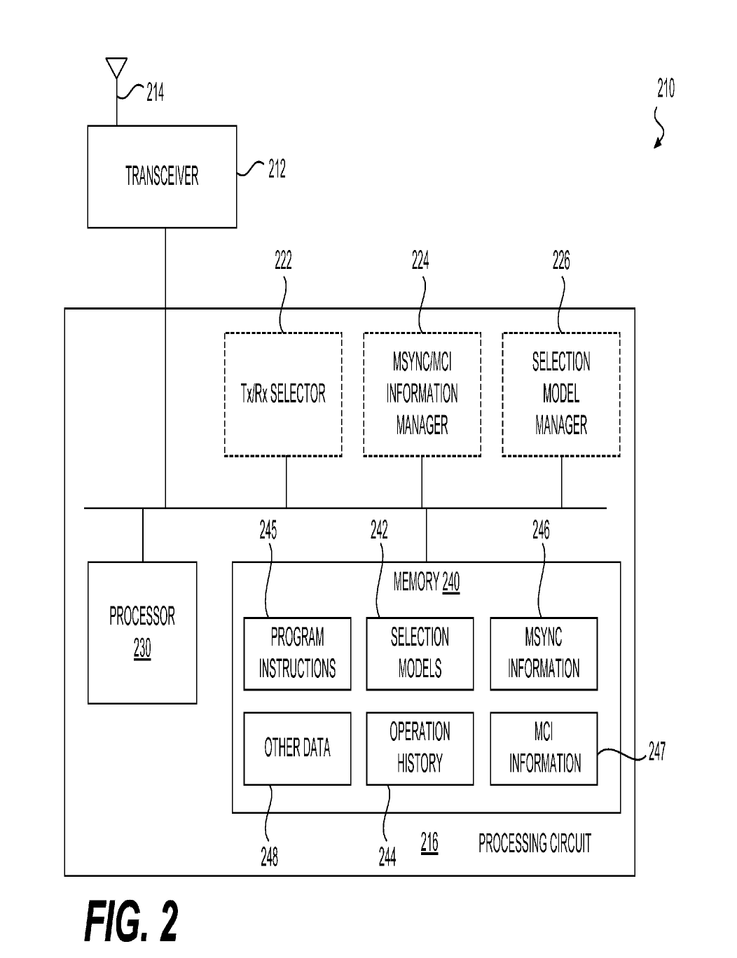

FIG. 2 shows an exemplary functional block diagram of a wireless device 210 according to an embodiment of the disclosure. The wireless device 210 may correspond to the wireless device 110 in the mesh network 100 in FIG. 1. The wireless device 210 can include a transceiver 212, an antenna 214, and a processing circuit 216. The transceiver 212 is capable of wirelessly communicating with another wireless device through the antenna 214 according to various communication protocols, such as the IEEE 802.11 based protocol, the IEEE 802.15 based protocol, or the like.

The processing circuit 216 includes a Tx/Rx selector 222, a MSYNC/MCI information manager 224, a selection model manager 226, a processor 230, and a memory 240. The memory 240 may store information including selection models 242, operation history information 244, program instructions 245, MSYNC information 246, MCI information 247, and/or other data 248.

The Tx/Rx selector 222 can determine and instruct the transceiver 212 with regard to whether the transceiver 212 is to transmit or receive MSYNC and/or MCI at any given MSYNC Tx/Rx window or MCI Tx/Rx window based on the corresponding selection models 242. The selection model manager 226 can update the selection models 242 based on the operation history information 244. In some examples, the Tx/Rx selector 222 can determine whether to transmit or receive a subsequent MSYNC at a subsequent MSYNC Tx/Rx window or whether to transmit or receive a subsequent MCI at a subsequent MCI Tx/Rx window in a manner similar to those described above with reference to the Tx/Rx selector 122, the selection models 132, and the operation history information 134.

The SYNC/MCI information manager 224 can generate an updated, consolidated version of MCI based on the MCI received from other wireless devices, the most up-to-date MCI currently stored in the wireless device 210 (e.g., included in the MCI information 247), and/or local network information that is part of the operation history information 244. The updated, consolidated version of MCI can be saved in the memory 240, either as an addition to the already stored MCI or to replace the stored MCI included in the MCI information 247.

For example, when the Tx/Rx selector 222 determines that the wireless device 210 is to receive the subsequent MCI during the subsequent MCI Tx/Rx window, the transceiver 212 may receive plural versions of the subsequent MCI from other wireless devices in the mesh network during the subsequent MCI Tx/Rx window. The SYNC/MCI information manager 224 of the processing circuit 216 may generate an updated, consolidated version of the subsequent MCI based on the plural versions of the subsequent MCI and/or the local network information collected by the wireless device 210. When the information embedded in different versions of MCI and the local network information is inconsistent, the SYNC/MCI information manager 224 may choose to keep the version from a more reliable wireless device, a wireless device with higher priority, a time stamp, or the like, which may be further provided in the received MSYNC and/or MCI or negotiated when joining the mesh network. In some examples, the transceiver 212 may receive the plural versions of the subsequent MCI during the subsequent MCI Tx/Rx window based on a Frequency Division Multiple Access (FDMA) approach, Time Division Multiple Access (TDMA) approach, Code Division Multiple Access (CDMA) approach, Space Division Multiple Access (SDMA) approach, and/or the like.

Also, the SYNC/MCI information manager 224 can update the MSYNC based on operation history information and previously received MSYNC. When the previously received MSYNC is inconsistent with the local network information, the SYNC/MCI information manager 224 may choose to keep the version from a more reliable wireless device, a wireless device with higher priority, a time stamp, or the like, which may be further provided in the received MSYNC and/or MCI or negotiated when joining the mesh network.

The selection model manager 226 can update the selection models 242, such as a MCI selection model or a MSYNC selection model, based on the operation history information 244. In some examples, the operation history information 244 may include the local network information, previously received MCI from other wireless device(s), reception signal quality of the previously received MCI, whether the wireless device transmitted or received MCI during a previous MCI Tx/Rx window, and a value of a random variable that corresponds to a probability function of likelihood of transmitting MCI among a predetermined number of MCI windows, and the like.

With respect to updating the MCI selection model, after comparing with the previously received MCI, when the local network information collected by the wireless device 210 includes updated and/or unique local knowledge of the mesh network that is inconsistent with the previously received MCI, such as establishing or losing a wireless connection with a neighboring wireless device, the MCI selection model may be updated to favor transmitting the subsequent MCI during the subsequent MCI Tx/Rx window. In some examples, when MCI versions from two or more different wireless devices are not identical, the MCI selection model may be updated to favor transmitting the subsequent MCI during the subsequent MCI Tx/Rx window. Otherwise, the MCI selection model may be updated to favor receiving the subsequent MCI during the subsequent MCI Tx/Rx window. The local network information collected by the wireless device 210 may include information with respect to direct communication link between the wireless device 210 and a neighboring wireless device, the creation or removal of such direct communication link, and/or the signal strength and channel status of such direct communication link.

In some examples, when the reception signal quality of the previously received MCI is lower than a first predetermined threshold, the MCI selection model may also be updated to favor transmitting the subsequent MCI during the subsequent MCI Tx/Rx window in order to propagate the updated information to other communication nodes of the mesh network. Under this scenario, the wireless device 210 may be barely within a communication range reachable by a wireless device that broadcasted the previously received MCI, and relaying the MCI by the wireless device 210 is justifiable in order to more efficiently propagate the MCI across the mesh network. Otherwise, the MCI selection model may be updated to favor receiving the subsequent MCI during the subsequent MCI Tx/Rx window.

Also, when a value of a random variable that corresponds to a probability function of likelihood of transmitting MCI among a predetermined number of prior MCI windows is lower than a second predetermined threshold, the wireless device 210 may favor transmitting the MCI during the subsequent MCI Tx/Rx window in order to balance the workload among various communication nodes. Otherwise, the MCI selection model may be updated to favor receiving the subsequent MCI during the subsequent MCI Tx/Rx window.

Moreover, the MCI selection model may be implemented based on stochastic modeling, where one or more random variables (e.g., a Bernoulli random variable) may be introduced to be evaluated in conjunction with one or more of the variables, such as variables associated with the aforementioned factors based on the operation history information 134. The MCI selection model implemented based on stochastic modeling may prevent two wireless devices that have similar operation history information to always concurrently transmit or receive MCI. In at least one embodiment, the MCI selection model implemented based on stochastic modeling can prevent a particular wireless device to transmit for more than a predetermined number of contiguous MCI Tx/RX windows, such as avoiding transmitting MCI for more than 8-12 contiguous MCI Tx/RX windows.

With respect to updating the MSYNC selection model, after analyzing and determining that the previously received MSYNC needs to be consolidated and/or further propagated to other wireless devices, the MSYNC selection model may be updated to favor transmitting the subsequent MSYNC during the subsequent MSYNC Tx/Rx window. In some examples, when the reception signal quality of the previously received MSYNC is lower than a third predetermined threshold, the MSYNC selection model may be updated to favor transmitting the subsequent MSYNC during the subsequent MSYNC Tx/Rx window. Under this scenario, the wireless device 210 may be barely reachable by the wireless device that broadcasted the previously received MSYNC, and transmitting the MSYNC by the wireless device 210 during the subsequent MSYNC Tx/Rx window is justifiable in order to reach out the communication nodes of the mesh network that may not be able to receive the previously received MSYNC. Otherwise, the MSYNC selection model may be updated to favor receiving the subsequent MSYNC during the subsequent MSYNC Tx/Rx window.

Also, when a value of a random variable that corresponds to a probability function of likelihood of transmitting MSYNC among a predetermined number of prior MSYNC windows is lower than a fourth predetermined threshold, the wireless device 210 may be updated to favor transmitting the MSYNC during the subsequent MSYNC Tx/Rx window in order to balance the workload among various communication nodes. Otherwise, the MSYNC selection model may be updated to favor receiving the subsequent MSYNC during the subsequent MSYNC Tx/Rx window.

Like the MCI selection model, the MSYNC selection model may also be implemented based on stochastic modeling, where one or more random variables (e.g., a Bernoulli random variable) may be introduced to be evaluated in conjunction with one or more of the variables associated with the aforementioned factors based on the operation history information 244. The MSYNC selection model implemented based on stochastic modeling may prevent two wireless devices that have similar operation history information to always concurrently transmit or receive MSYNC. In at least one embodiment, the MSYNC selection model implemented based on stochastic modeling can prevent a particular wireless device to transmit for more than a predetermined number of contiguous MSYNC Tx/RX windows, such as avoiding transmitting MSYNC for more than 8-12 contiguous MSYNC Tx/RX windows.

The processor 230 can be configured to execute program instructions 245 stored in the memory 240 to perform various functions. The processor 230 can include a single or multiple processing cores. Various components of the processing circuit 216, such as the Tx/Rx selector 222, MSYNC/MCI information manager 224, and/or selection model manager 226, may be implemented by hardware components, the processor 230 executing the program instructions, or a combination thereof. Of course, the processor 230 can also execute program instructions 245 to perform other functions for the wireless device 210 that are not described in the present disclosure.

The memory 240 can be used to store the program instructions 245 and information such the selection models 242, operation history information 244, MSYNC information 246, MCI information 247, other data 248, and/or intermediate data. In some examples, the memory 240 includes a non-transitory computer readable medium, such as a semiconductor or solid-state memory, a random access memory (RAM), a read-only memory (ROM), a hard disk, an optical disk, or other suitable storage medium. In some embodiments, the memory 240 includes a combination of two or more of the non-transitory computer readable mediums listed above.

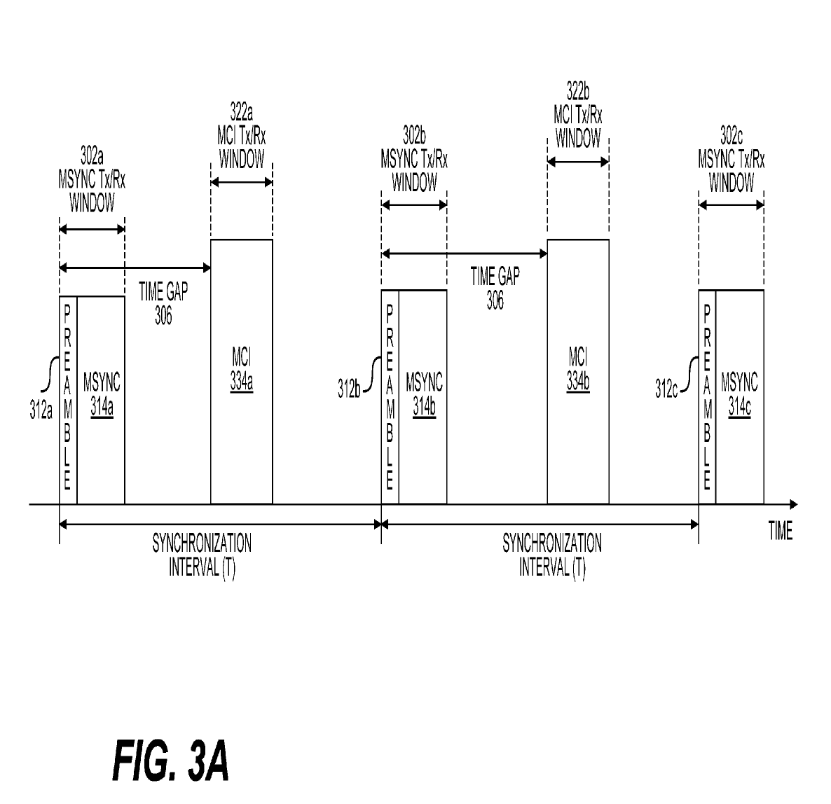

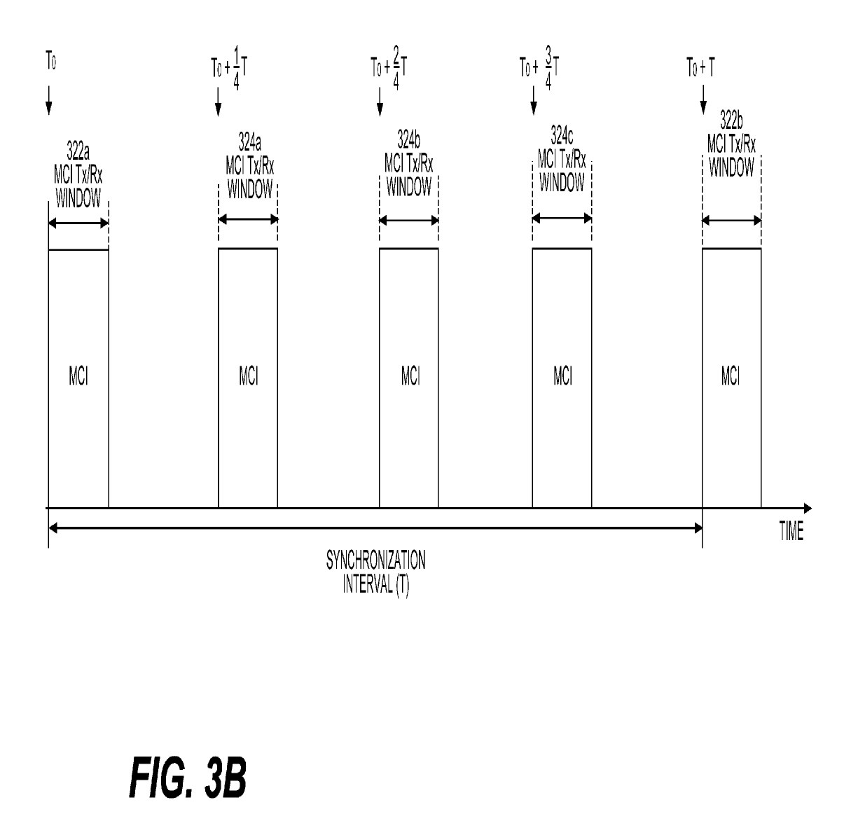

FIG. 3A shows an exemplary timing diagram of a control channel of a mesh network, such as the mesh network 100 in FIG. 1, according to an embodiment of the disclosure. A plurality of MSYNC Tx/Rx windows may be repetitively allocated on the control channel, where every two contiguous MSYNC Tx/Rx windows may be set apart by a predetermined synchronization interval T. During each MSYNC Tx/Rx window, a preamble 312a, 312b, or 312c is broadcasted at the starting time of the MSYNC Tx/Rx window and followed by MSYNC 314a, 314b, or 314c. A MCI Tx/Rx window 322a or 322b may be defined based on a time gap 306 between a starting time of the MCI Tx/Rx window 322a or 322b and a corresponding MSYNC Tx/Rx window 302a or 302b as defined in the predetermined mesh network protocol. MCI 334a and 334b can be broadcasted during the allocated MCI Tx/Rx windows 322a and 322b.

In some examples, the time gap 306 can be a fixed value defined in the mesh network protocol. In some examples, the time gap 306 can be a value determined based on the information embedded in the MSYNC 314a or 314b. Also, which MSYNC Tx/RX windows 302a, 302b, and 302c would be followed by a MCI Tx/Rx window 322a or 322b can be determined based on the predetermined mesh network protocol and/or information embedded in the MSYNC 314a. 314b, and/or 314c. One MSYNC Tx/RX window and at least one MCI Tx/Rx window may be allocated within a synchronization interval T. Of course, some synchronization interval T can have one MSYNC Tx/RX window without any MCI Tx/Rx window.

A wireless device, such as the wireless device 110 or the wireless device 210, can identify MSYNC Tx/RX windows based on detecting the preambles 312a, 312b, or 312c, the information embedded in the received MSYNC 314a, 314b, or 314c, and/or the definitions provided in the predetermined mesh network protocol. Also, the wireless device can identify MCI Tx/Rx windows based on the detected MSYNC Tx/Rx window, the information embedded in the received MSYNC, and/or the definitions provided in the predetermined mesh network protocol. Of course, the knowledge regarding the MSYNC Tx/RX windows and/or the MCI Tx/Rx windows may be obtained by the wireless device that participates in the mesh network from other sources consistent with the corresponding mesh network protocol.

FIG. 3B shows an exemplary timing diagram for illustrating an allocation of MCI Tx/Rx windows according to an embodiment of the disclosure. In some examples, two or more MCI Tx/Rx windows 322a, 324a, 324b, and 324c may be allocated within a synchronization interval T. For example, each synchronization interval T may have a MCI Tx/Rx window 322a or 322b that is identifiable based on the starting time of the corresponding MSYNC Tx/Rx window 302a or 302b. Moreover, one or more additional MCI Tx/Rx windows may be allocated between MCI Tx/Rx window 322a and 322b.

With reference to FIG. 3B, three MCI Tx/Rx windows 324a, 324b, and 324c are allocated between MCI Tx/Rx windows 322a and 322b. Accordingly, the synchronization interval T between the starting time of the MCI Tx/Rx window 322a (T₀) and the starting time of the MCI Tx/Rx window 322b (T₀+T) may include four MCI Tx/Rx windows 322a, 324a, 324b, and 324c allocated therein. The starting time of every two contiguous MCI Tx/Rx windows thus may be ¼T. For example, the starting time of MCI Tx/Rx windows 324a, 324b, and 324c may be set at T₀+¼T, T₀+ 2/4T, and T₀+¾T, respectively. Of course, different number of MCI Tx/Rx windows may be allocated within a synchronization interval T. The number of MCI Tx/Rx windows allocated within a synchronization interval T may be a fixed number as provided in the predetermined mesh network protocol or determinable based on the information embedded in the received MSYNC and/or MCI.

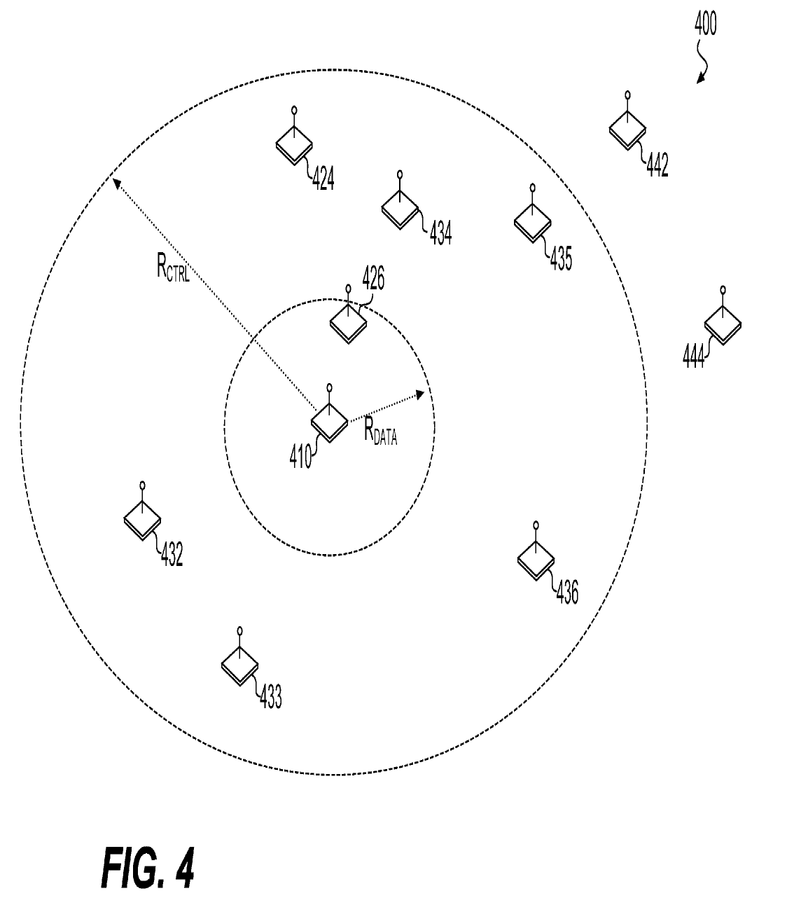

FIG. 4 shows an exemplary diagram of a mesh network 400 for illustrating various effective communication ranges of a wireless device 410 according to an embodiment of the disclosure. The mesh network 400 may include wireless devices 410, 424, 426, 432, 433, 434, 435, 436, 442, and 444 that function as communication nodes of the mesh network 400 in a manner similar to the mesh network 100 in FIG. 1. The wireless device 410 may communicate with one or more wireless devices using a data traffic channel for data communication and using a control channel for propagating network coordination information. The data traffic channel and the control channel may use difference radio frequency bands, same radio frequency band with different time allocations, same radio frequency band with different coding schemes, a combination thereof, or the like.

The wireless device 410 may have an effective range R_{DATA} reachable by the wireless device 410 when using the data traffic channel and have an effective range R_{CTRL} reachable by the wireless device 410 when using the control channel. As shown in FIG. 4, the effective communication range R_{DATA} reachable by the wireless device 410 when using the data traffic channel is less than the effective communication range R_{CTRL} reachable by the wireless device 410 when using the control channel. Therefore, as shown in FIG. 4 for example, wireless device 426 is reachable by the wireless device 410 using the data traffic channel; and wireless devices 424, 426, 432, 433, 434, 435, and 436 are reachable by the wireless device 410 using the control channel. Wireless devices 442 and 444 may not be reachable by the wireless device 410, either using the data traffic channel or the control channel.

In some examples, the difference between the effective communication ranges R_{DATA} and R_{CTRL} can result from one or more of setting a carrier frequency of the control channel to be lower than a carrier frequency of the data traffic channel, adopting a coding scheme for the control channel that is more redundant and robust than a coding scheme for the data traffic channel, allowing at any given time a less number of communication nodes that are transmitting using the control channel than the communication nodes that are transmitting using the data traffic channel, and/or the like.

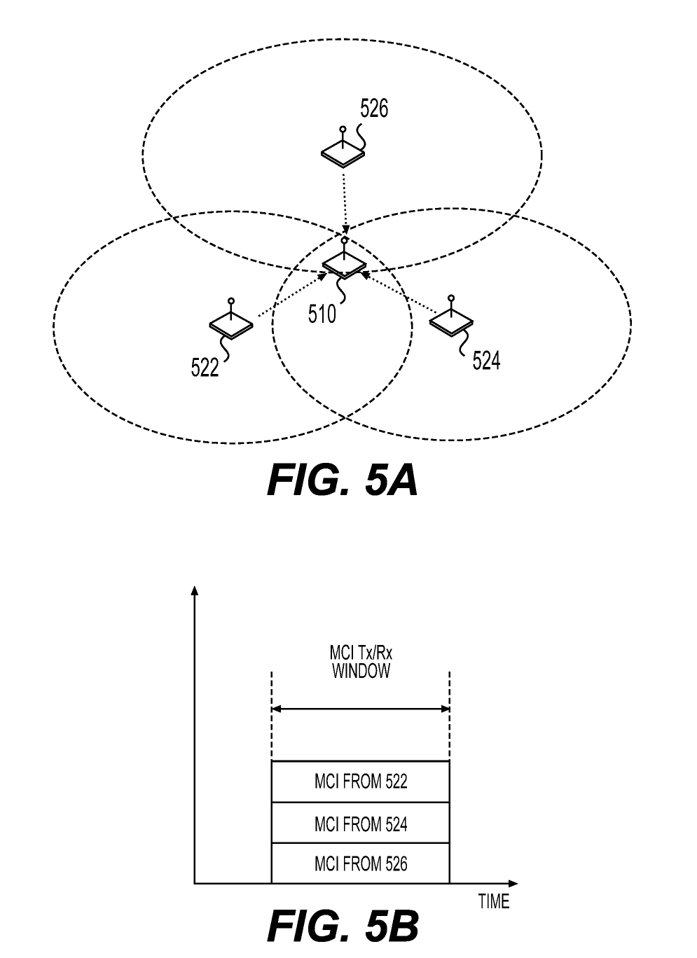

FIG. 5A shows an exemplary diagram of a wireless device 510 that receives mesh control information (MCI) from other wireless devices 522, 524, and 526 during a given MCI transmitting/receiving (Tx/Rx) window according to an embodiment of the disclosure. FIG. 5B shows an exemplary timing diagram of receiving MCI from plural wireless devices 522, 524, and 526 during the given MCI Tx/Rx window according to an embodiment of the disclosure.

As shown in FIGS. 5A and 5B, the wireless device 510 may correspond to the wireless device 110 in FIG. 1. When it is determined that the wireless device 510 is to receive MCI during the given MCI Tx/Rx window, the wireless device 510 may receive plural versions of the MCI from other wireless devices in the mesh network, such as from wireless devices 522, 524, and 526. The versions of MCI from different wireless devices may be broadcasted in a manner that the wireless device 510 would be able to distinctively receive and decode these different versions of MCI. In some examples, the plural versions of MCI during the given MCI Tx/Rx window may be broadcasted based on a FDMA approach, TDMA approach, CDMA approach, SDMA approach, and/or the like, so long as the wireless device 510 can successfully decode messages originating from different wireless devices even if they overlap in time and/or frequency domain. After receiving the plural versions of MCI from the wireless devices 522, 524, and 526, the wireless device 510 may generate a consolidated version of the MCI based on the plural versions of the MCI and/or the local network information collected by the wireless device 510.

Also, when the information embedded in different versions of MCI and the local network information is inconsistent, the wireless device 510 may choose to keep the version from a more reliable wireless device, a wireless device with higher priority, a time stamp, or the like, which may be further provided in the received MSYNC and/or MCI or negotiated when joining the mesh network.

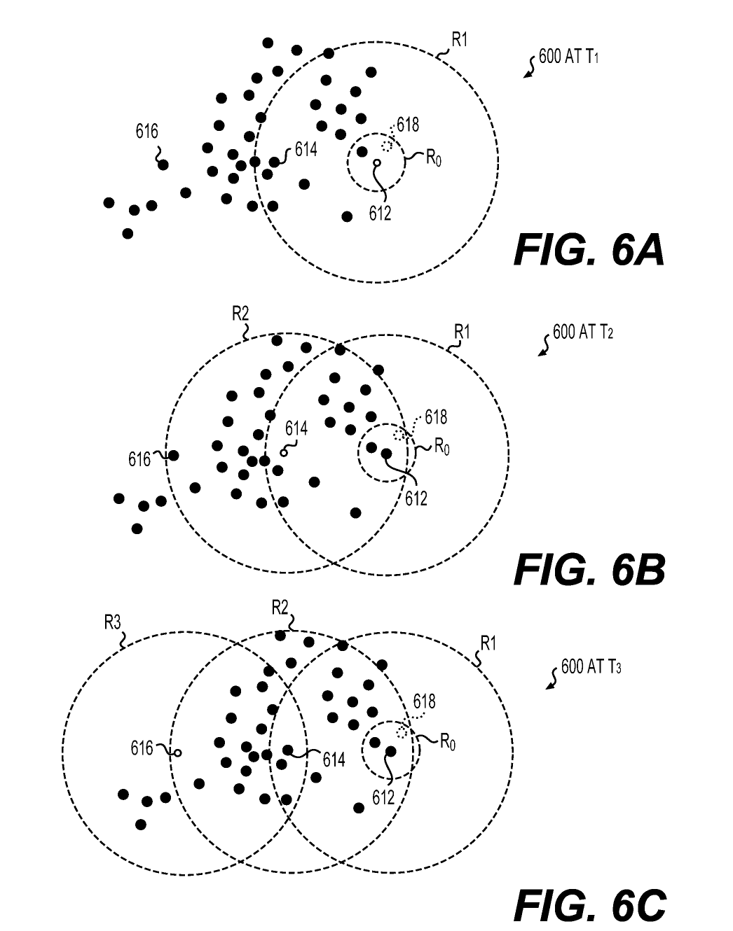

FIGS. 6A-6C shows exemplary diagrams of a mesh network 600 at different stages, such as at time T₁, T₂, and T₃, respectively, for illustrating propagating MCI across the mesh network according to an embodiment of the disclosure. The mesh network 600 includes a plurality of wireless devices depicted as solid or hollow dots, including at least wireless devices 612, 614, and 616. Each of the wireless devices in the mesh network 600 is capable of communicating with one or more neighboring wireless devices using a data traffic channel and broadcasting or receiving MSYNC and/or MCI using a control channel in a manner discussed with references to FIGS. 1-5B. Also, each of the wireless devices in the mesh network 600 may have its own MCI selection model and/or MSYNC Tx/Rx selection and can individually determine whether to transmit or receive MCI or MSYNC based on the operation history information it possesses.

As shown in FIG. 6A, at time T₁ that corresponds to a first MCI Tx/Rx window, the wireless device 612 may determine to broadcast MCI using the control channel, which may have an effective communication rage R₁. The wireless device 612 is depicted as a hollow dot indicating that the wireless device 612 is transmitting the MCI at time T₁. The wireless nodes within the effective communication rage R₁, including wireless device 614, would be able to receive the MCI broadcasted by the wireless device 612 at time T₁. Meanwhile, the wireless device 612 can communicate with a neighboring wireless device using the data traffic channel, which may have an effective communication rage R₀ less than the effective communication rage R₁. In some examples, the wireless device 612 may determine to broadcast MCI based on its MCI selection model. The reasons for the MCI selection model to favor transmitting the MCI may be loss of a wireless connection between a wireless device 618 and the wireless device 612 using the data traffic channel, receiving more up-to-date MCI from a previous MCI Tx/Rx window, and/or for sharing the workload of broadcasting the MCI. For example, the reason for the wireless 612 to broadcast the MCI at time T₁ is to announce the disconnection of the wireless device 618. As a result, all the communication devices within the effective communication rage R₁ are aware of the disconnection of the wireless device 618.

As shown in FIG. 6B, at time T₂ that corresponds to a second MCI Tx/Rx window, the wireless device 614 may determine to broadcast MCI using the control channel, while the wireless devices 612 and 616 may determine to receive MCI. The wireless device 614 is depicted as a hollow dot indicating that the wireless device 614 is transmitting the MCI at time T₂. The wireless device 614 may have an effective communication rage R₂ when using the control channel. The wireless nodes within the effective communication rage R₂, including wireless devices 612 and 614, would be able to receive the MCI broadcasted by the wireless device 614 at time T₂. Therefore, the updated MCI can be propagated to the wireless devices that are within the effective communication rage R₂ but not within the effective communication rage R₁. The wireless device 614 may determine to broadcast MCI based on its MCI selection model. The reasons for the MCI selection model to favor transmitting the MCI may be the updated information embedded in the MCI from the wireless device 612, the signal quality of the MCI from the wireless device 612 is too low and thus further relaying the MCI would be preferred, and/or for sharing the workload of broadcasting the MCI. In an example that the reason for the wireless 614 to broadcast the MCI at time T₂ is to relay the updated information from the wireless device 612, i.e., the disconnection of the wireless device 618, to all the communication devices within the effective communication rage R₂.

As shown in FIG. 6C, at time T₃ that corresponds to a third MCI Tx/Rx window, the wireless device 616 may determine to broadcast MCI using the control channel, while the wireless devices 612 and 614 may determine to receive MCI. The wireless device 616 is depicted as a hollow dot indicating that the wireless device 616 is transmitting the MCI at time T₃. The wireless device 616 may have an effective communication rage R₃ when using the control channel. The wireless nodes within the effective communication rage R₃, including wireless device 614, would be able to receive the MCI broadcasted by the wireless device 616 at time T₃. Therefore, the updated MCI can be propagated to the wireless devices that are within the effective communication rage R₃ but not within the effective communication rage R₁ or R₂. Similar to the wireless device 614, the wireless device 616 may determine to broadcast MCI based on its MCI selection model. The reasons for the MCI selection model to favor transmitting the MCI may be the updated information embedded in the MCI from the wireless device 614, the signal quality of the MCI from the wireless device 614 is too low and thus further relaying the MCI would be preferred, and/or for sharing the workload of broadcasting the MCI. In an example that the reason for the wireless 616 to broadcast the MCI at time T₃ is to relay the updated information from the wireless device 612, i.e., the disconnection of the wireless device 618, to all the communication devices within the effective communication rage R₃.

At this stage, the MCI as initially updated and broadcasted by wireless device 612 is propagated to all wireless devices covered by the effective communication rage R₁, R₂, and R₃. Compared with a configuration that the MCI is forwarded one communication node to another at a time, the updated MCI can be propagated across the mesh network 600 more efficiently. Also, the MCI selection model allows individual wireless device to make decision with respect to whether to transmit or receive the MCI at any given MCI Tx/Rx window, and thus reduces the mesh network management overhead. Moreover, the MCI selection model may be designed to minimize the likelihood of collisions of MCI transmissions, and may be implemented with simplified or without additional collision-avoidance protocol for the MCI transmissions.

Although FIGS. 6A-6C only illustrate propagating MCI in the mesh network 600, the propagation and broadcasting of the MSYNC may have similar effects, and detailed description thereof is thus omitted.

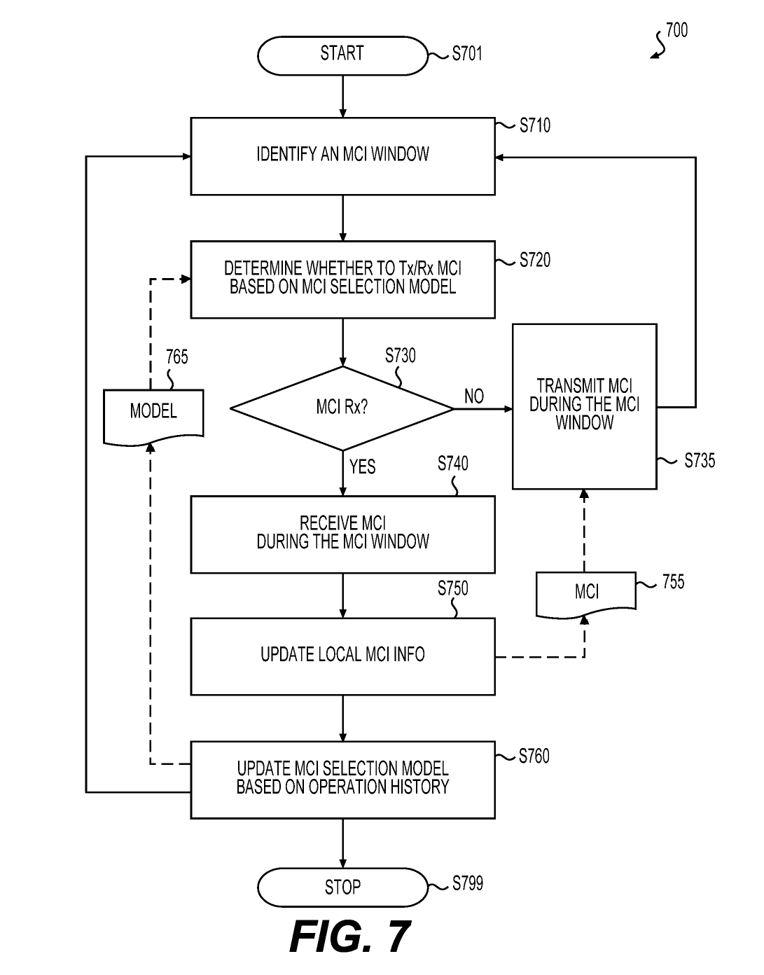

FIG. 7 shows an exemplary flow chart outlining a process 700 for determining whether to transmit or receive subsequent MCI of a mesh network during a subsequent MCI Tx/Rx window according to an embodiment of the disclosure. The process 700 may be performed by a wireless device in the mesh network, such as the wireless device 110 in the mesh network 100 in FIG. 1. It is understood that additional operations may be performed before, during, and/or after the process 700 depicted in FIG. 7. The process 700 starts at S701 and proceeds to S710.

At S710, a subsequent MCI Tx/Rx window is identified. The subsequent MCI Tx/Rx window may be identified as defined according to a predetermined mesh network protocol. The subsequent MCI Tx/Rx window may be identified based on the predetermined mesh network protocol as well as a corresponding MSYNC Tx/Rx window and/or information embedded in previously received MSYNC and/or MCI. For example, the processing circuit 116 or 216 may identify a subsequent MCI Tx/Rx window in a manner as described with reference to FIGS. 1-3B.

At S720, whether to transmit or receive the subsequent MCI at the subsequent MCI Tx/Rx window based on a MCI selection model 765. The MCI selection model 765 may be constantly updated based on operation history information. For example, the Tx/Rx selector 122 or 222 of the processing circuit 116 or 216 may determine whether to transmit or receive the subsequent MCI at the subsequent MCI Tx/Rx window based on the MCI selection model as described with reference to FIGS. 1 and 2.

At S730, when it is determined to transmit the subsequent MCI at the subsequent MCI Tx/Rx window, the process proceeds to S735. When it is determined to receive the subsequent MCI at the subsequent MCI Tx/Rx window, the process proceeds to S740.

At S735, a version of MCI 755 is transmitted at the subsequent MCI Tx/Rx window using a control channel of the mesh network. The control channel of the mesh network may have an effective communication range greater than a data traffic channel of the mesh network. In some examples, the version of MCI 755 to be transmitted may include the most up-to-date information based on consolidating previously received MCI as well as operation history information of the transmitting wireless device. Also, the MCI 755 may be transmitted based on a FDMA approach, TDMA approach, CDMA approach, SDMA approach, and/or the like, in order to allow multiple versions of the MCI to be distinctively broadcasted at the subsequent MCI Tx/Rx window. For example, the Tx/Rx selector 122 or 222 of the processing circuit 116 or 216 may instruct the transceiver 112 or 212 to transmit a version of MCI stored in the memory 240 at the subsequent MCI Tx/Rx window as described with reference to FIGS. 1, 2, 4, and 5A-5B.

At S740, one or more versions of MCI are received at the subsequent MCI Tx/Rx window using the control channel of the mesh network. In some examples, the one or more versions of MCI may be broadcasted based on a FDMA approach, TDMA approach, CDMA approach, SDMA approach, and/or the like. For example, the Tx/Rx selector 122 or 222 of the processing circuit 116 or 216 may instruct the transceiver 112 or 212 to receive one or more versions of MCI at the subsequent MCI Tx/Rx window as described with reference to FIGS. 1, 2, 4, and 5A-5B.

At S750, the version of MCI 755 is updated based on the received one or more versions of MCI. The MCI 755 may be transmitted at S735 during the next iteration. The MCI 755 may also be updated based on operation history information. For example, the MSYNC/MCI information manager 224 may update the MCI (e.g., the MCI information 247) stored in the memory 240 as described with reference to FIG. 2.

At S760, the MCI selection model 765 may be updated based operation history information. In some examples, updating the MCI selection model 765 may correspond to updating various parameters or alerting decision paths of a decision-tree algorithm of the MCI selection model 765 based on the operation history information. Also, the MCI selection model 765 may be implemented based on stochastic modeling, where one or more random variables may be introduced. For example, the selection model manager 226 may update the MCI selection model (e.g., the selection models 242) stored in the memory 240 as described with reference to FIG. 2.

After S760, if the wireless device remains in the mesh network, the process proceeds to S710 for transmitting or receiving the MCI at the next MCI Tx/Rx window. Otherwise, the process proceeds to S799 and terminates.

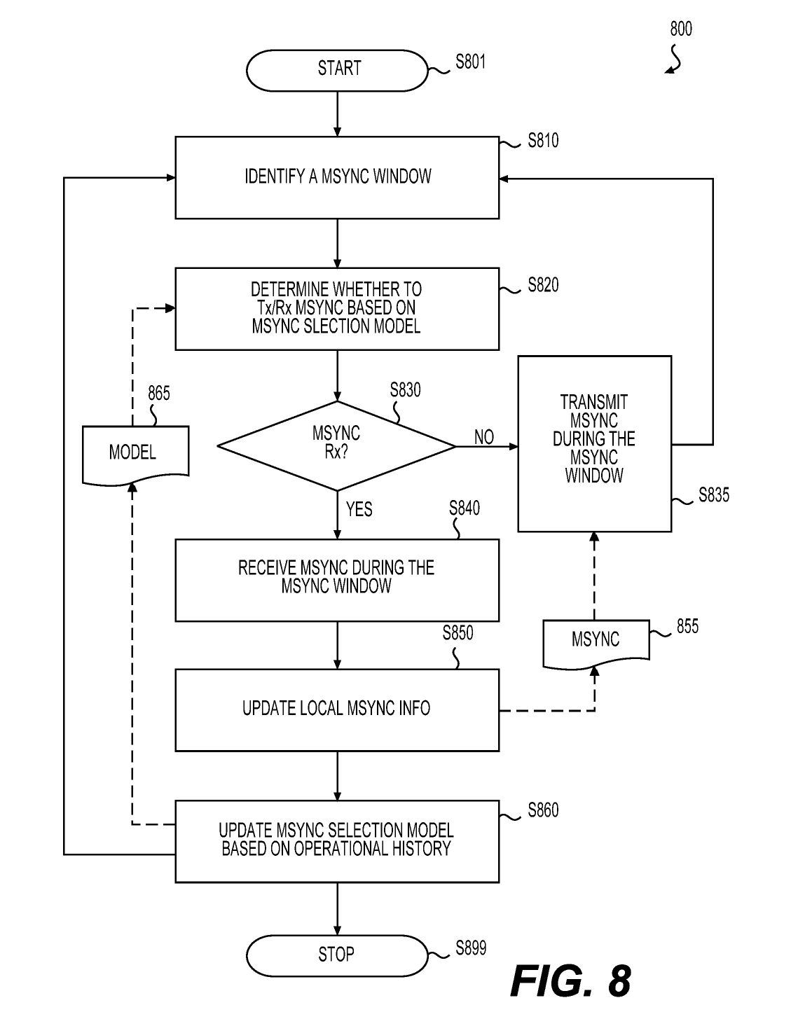

FIG. 8 shows an exemplary flow chart outlining a process 800 for determining whether to transmit or receive subsequent mesh synchronization information (MSYNC) of a mesh network during a subsequent MSYNC Tx/Rx window according to an embodiment of the disclosure. The process 800 may be performed by a wireless device in the mesh network, such as the wireless device 110 in the mesh network 100 in FIG. 1. It is understood that additional operations may be performed before, during, and/or after the process 800 depicted in FIG. 8. The process 800 starts at S801 and proceeds to S810.

At S810, a subsequent MSYNC Tx/Rx window is identified. The subsequent MSYNC Tx/Rx window may be identified as defined according to a predetermined mesh network protocol. The subsequent MSYNC Tx/Rx window may be identified based on the predetermine mesh network protocol as well as a detected signature of a transmission frame, such as a preamble indicating a starting time of a MSYNC Tx/Rx window, and/or information embedded in previously received MSYNC. For example, the processing circuit 116 or 216 may identify a subsequent MSYNC Tx/Rx window in a manner as described with reference to FIGS. 1-3A.

At S820, whether to transmit or receive the subsequent MSYNC at the subsequent MSYNC Tx/Rx window based on a MSYNC selection model 865. The MSYNC selection model 865 may be constantly updated based on operation history information. For example, the Tx/Rx selector 122 or 222 of the processing circuit 116 or 216 may determine whether to transmit or receive the subsequent MSYNC at the subsequent MSYNC Tx/Rx window based on the MSYNC selection model as described with reference to FIGS. 1 and 2.

At S830, when it is determined to transmit the subsequent MSYNC at the subsequent MSYNC Tx/Rx window, the process proceeds to S835. When it is determined to receive the subsequent MSYNC at the subsequent MSYNC Tx/Rx window, the process proceeds to S840.

At S835, MSYNC 855 is transmitted at the subsequent MSYNC Tx/Rx window using a control channel of the mesh network. The control channel of the mesh network may have an effective communication range greater than a data traffic channel of the mesh network. In some examples, the MSYNC 855 to be transmitted may include the most up-to-date information based on previously received MSYNC as well as information exchanged among the wireless devices of the mesh network. For example, the Tx/Rx selector 122 or 222 of the processing circuit 116 or 216 may instruct the transceiver 112 or 212 to transmit MSYNC stored in the memory 240 at the subsequent MSYNC Tx/Rx window as described with reference to FIGS. 1, 2, 4, and 5A-5B.

At S840, the broadcasted MSYNC is received at the subsequent MSYNC Tx/Rx window using the control channel of the mesh network. For example, the Tx/Rx selector 122 or 222 of the processing circuit 116 or 216 may instruct the transceiver 112 or 212 to receive the broadcasted MSYNC at the subsequent MSYNC Tx/Rx window as described with reference to FIGS. 1, 2, 4, and 5A-5B.

At S850, a version of MSYNC 855 is updated if there is any more up-to-date information embedded in the received MSYNC. The MSYNC 855 may be transmitted at S835 during the next iteration. The MSYNC 855 may also be updated based on operation history information. For example, the MSYNC/MCI information manager 224 may update the MSYNC (e.g., the MSYNC information 246) stored in the memory 240 as described with reference to FIG. 2.

At S860, the MSYNC selection model 865 may be updated based operation history information. In some examples, updating the MSYNC selection model 865 may correspond to updating various parameters or alerting decision paths of a decision-tree algorithm of the MSYNC selection model 865 based on the operation history information. Also, the MSYNC selection model 865 may be implemented based on stochastic modeling, where one or more random variables may be introduced. For example, the selection model manager 226 may update the MSYNC selection model (e.g., the selection models 242) stored in the memory 240 as described with reference to FIG. 2.

After S860, if the wireless device remains in the mesh network, the process proceeds to S810 for transmitting or receiving the MSYNC at the next MSYNC Tx/Rx window. Otherwise, the process proceeds to S899 and terminates.

Of course, a wireless device may be configured to perform both of the processes 700 and 800 based on the predetermined mesh network protocol. In some examples, a wireless device may be configured to perform only one of the processes 700 and 800, depending on the configuration as defined in the predetermined mesh network protocol.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A wireless device in a mesh network, the wireless device comprising:
a processing circuit configured to:
update a first selection model based on first operation history information of operating the wireless device in the mesh network; and
determine whether the wireless device is to transmit or receive subsequent mesh control information (MCI) of the mesh network during a subsequent MCI transmitting/receiving (Tx/Rx) window based on the first selection model; and
a transceiver configured to transmit or receive the subsequent MCI during the subsequent MCI Tx/Rx window as determined based on the first selection model.

2. The wireless device of claim 1, wherein the first operation history information includes at least local network information, previously received MCI from another wireless device, reception signal quality of the previously received MCI, whether the wireless device transmitted or received MCI during a previous MCI Tx/Rx window, or a value of a random variable that corresponds to a probability function of likelihood of transmitting MCI among a predetermined number of MCI windows.

3. The wireless device of claim 2, wherein the processing circuit is configured to determine based on the first selection model that the wireless device is to transmit the subsequent MCI during the subsequent MCI Tx/Rx window when:
the local network information is inconsistent with the previously received MCI,
the reception signal quality of the previously received MCI is less than a first predetermined threshold, or
the value of the random variable is less than a second predetermined threshold.

4. The wireless device of claim 1, wherein
the processing circuit is further configured to:
update a second selection model based on second operation history information of operating the wireless device in the mesh network; and
determine whether the wireless device is to transmit or receive subsequent mesh synchronization information (MSYNC) of the mesh network during a subsequent MSYNC Tx/Rx window based on the second selection model, and
the transceiver is further configured to transmit or receive the subsequent MSYNC during the subsequent MSYNC Tx/Rx window as determined based on the second selection model.

5. The wireless device of claim 4, wherein the second operation history information includes at least previously received MSYNC, reception signal quality of the previously received MSYNC, whether the wireless device transmitted or received MSYNC during a previous MSYNC Tx/Rx window, or a value of a random variable that corresponds to a probability function of likelihood of transmitting MSYNC among a predetermined number of MSYNC windows.

6. The wireless device of claim 5, wherein the processing circuit is configured to determine based on the second selection model that the wireless device is to transmit the subsequent MSYNC during the subsequent MSYNC Tx/Rx window when:
the previously received MSYNC is determined to be further propagated,
the reception signal quality of the previously received MSYNC is less than a third predetermined threshold, or
the value of the random variable is less than a fourth predetermined threshold.

7. The wireless device of claim 4, wherein the processing circuit is further configured to:
determine the subsequent MSYNC Tx/Rx window based on a predetermined mesh network protocol; and
determine the subsequent MCI Tx/Rx window based on at least the subsequent MSYNC Tx/Rx window, the predetermined mesh network protocol, or information embedded in received MSYNC.

8. The wireless device of claim 1, wherein
the processing circuit is configured to identify a control channel of the mesh network based on received MSYNC, and
the transceiver is configured to transmit or receive the subsequent MCI through the identified control channel.

9. The wireless device of claim 1, wherein
the processing circuit is configured to identify a data traffic channel of the mesh network based on information embedded in received MCI; and
the transceiver is configured to transmit or receive user data through the identified data traffic channel.

10. The wireless device of claim 9, wherein an effective communication range reachable by the wireless device using the data traffic channel is less than an effective communication range reachable by the wireless device using the control channel.

11. The wireless device of claim 9, wherein a carrier frequency of the data traffic channel is greater than a carrier frequency of the control channel.

12. The wireless device of claim 1, wherein, when the wireless device is determined to receive the subsequent MCI during the subsequent MCI Tx/Rx window,
the transceiver is further configured to receive plural versions of the subsequent MCI from other wireless devices in the mesh network during the subsequent MCI Tx/Rx window; and
the processing circuit is further configured to generate a consolidated version of the subsequent MCI based on the plural versions of the subsequent MCI.

13. The wireless device of claim 12, wherein the transceiver is configured to receive the plural versions of the subsequent MCI during the subsequent MCI Tx/Rx window based on a Frequency Division Multiple Access (FDMA), Time Division Multiple Access (TDMA), Code Division Multiple Access (CDMA), or Space Division Multiple Access (SDMA) approach.

14. The wireless device of claim 12, wherein the processing circuit is configured to generate the consolidated version of the subsequent MCI further based on local network information.

15. A method for a wireless device in a mesh network, the method comprising:
updating a first selection model based on first operation history information of operating the wireless device in the mesh network;
determining, by a processing circuit of the wireless device based on the first selection model, whether the wireless device is to transmit or receive a subsequent mesh control information (MCI) of the mesh network during a subsequent MCI transmitting/receiving (Tx/Rx) window; and
transmitting or receiving, by a transceiver of the wireless device, the subsequent MCI during the subsequent MCI Tx/Rx window as determined based on the first selection model.

16. The method of claim 15, wherein the first operation history information includes at least local network information, previously received MCI from another wireless device, reception signal quality of the previously received MCI, whether the wireless device transmitted or received MCI during a previous MCI Tx/Rx window, or a value of a random variable that corresponds to a probability function of likelihood of transmitting MCI among a predetermined number of MCI windows.

17. The method of claim 16, further comprising determining based on the first selection model that the wireless device is to transmit the subsequent MCI during the subsequent MCI Tx/Rx window when:
the local network information is inconsistent with the previously received MCI,
the reception signal quality of the previously received MCI is less than a first predetermined threshold, or
the value of the random variable is less than a second predetermined threshold.

18. The method of claim 15, further comprising:
updating a second selection model based on second operation history information of operating the wireless device in the mesh network;
determining, by the processing circuit of the wireless device based on the second selection model, whether the wireless device is to transmit or receive subsequent mesh synchronization information (MSYNC) of the mesh network during a subsequent MSYNC Tx/Rx window; and
transmitting or receiving the subsequent MSYNC during the subsequent MSYNC Tx/Rx window as determined based on the second selection model.

19. A non-transitory computer readable medium storing program instructions for causing a processing circuit of a wireless device to perform the steps of:
updating a first selection model based on first operation history information of operating the wireless device in the mesh network;
determining, by the processing circuit of the wireless device based on the first selection model, whether the wireless device is to transmit or receive a subsequent mesh control information (MCI) of the mesh network during a subsequent MCI transmitting/receiving (Tx/Rx) window; and
transmitting or receiving, by a transceiver of the wireless device, the subsequent MCI during the subsequent MCI Tx/Rx window as determined based on the first selection model.

20. The non-transitory computer readable medium of claim 19, wherein the program instructions is further for causing the processing circuit of the wireless device to perform the steps of:
updating a second selection model based on second operation history information of operating the wireless device in the mesh network;
determining, by the processing circuit of the wireless device based on the second selection model, whether the wireless device is to transmit or receive subsequent mesh synchronization information (MSYNC) of the mesh network during a subsequent MSYNC Tx/Rx window; and
transmitting or receiving the subsequent MSYNC during the subsequent MSYNC Tx/Rx window as determined based on the second selection model.
